(19) United States
(12) Patent Application Publication
(10) Pub. No.: US 2014/0327257 A1
(43) Pub. Date: Nov. 6, 2014

(54) TOOL FOR REMOVING A SWIMMING POOL SKIMMER BASKET

(71) Applicant: MAVO Industries, LLC, Loganville, GA (US)

(72) Inventor: Maria M. Vazquez, Loganville, GA (US)

(21) Appl. No.: 13/875,023

(22) Filed: May 1, 2013

(51) Int. Cl. B25J 1/04

(52) U.S. Cl. CPC B25J 1/04
USPC 294/24; 294/97; 294/195

(57) ABSTRACT

The present invention provides a tool designed to remove a swimming pool skimmer basket for cleaning without having to touch the debris trapped therein. The tool provided for herein takes the general appearance of a pair of tongs having a uniquely constructed grasping portion. The grasping portion of the tongs provides several ways to remove the skimmer basket from the skimmer for cleaning and facilitates removal of debris directly from the skimmer basket.

### BACKGROUND OF THE INVENTION

1. Field of the Invention

This invention generally relates to tools used for pool maintenance. More particularly, the present invention related to tools used to handle and clean the skimmer basket of a swimming pool skimmer.

2. Description of the Prior Art

Swimming pools require constant maintenance for them to remain sanitary for recreational use. The least labor intensive method, and arguably the most effective way, of removing floating debris from a pool is through the use of a static skimmer. Static skimmers generally rely on a skimmer basket which is housed within a well of the skimmer. The well is covered by a lid. As water is drawn through the skimmer and skimmer basket, floating debris is trapped therein. Floating debris typically includes leaves, twigs, insects, small animals, pollen and generally any foreign object which floats long enough to be sucked into the skimmer basket. The animals may be alive or in a stage of decay. As a result of debris build up the skimmer basket must be periodically cleaned out; an undesirable task considering what is trapped therein. Without some type of purpose built tool the skimmer basket has to be removed by hand, an unsanitary task.

The prior art has provided various tools to remove swimming pool skimmer baskets. One such example is described in U.S. Patent Publication No. 2009/0243318A1 to Pratt. This design provides a tool which is designed to remove a skimmer basket without the user needing to lay hands on the basket itself. Some of the obvious shortcomings of this design are as follows. The Pratt design relies on the presence of a skimmer basket handle which may be broken or not present on some designs. It also lacks any utility to assist the user in removing the lid typically covering the skimmer well which houses the skimmer basket. Further, no provision has been made for the tool to assist the user in the removal of live animals.

Therefore in consideration of what is available in the prior art, there exist a need for a skimmer basket removal tool that remedies the foregoing and other deficiencies inherent in the prior art.

### SUMMARY OF THE INVENTION

In view of the foregoing, one object of the present invention is to overcome the shortcomings in the design of skimmer basket removal tools as described above.

Another object of the present invention is to provide a skimmer basket removal tool which is capable of grasping and removing a skimmer basket having a handle.

Yet another object of the present invention is to provide a skimmer basket removal tool in accordance with preceding objects which has a provision to facilitate the removal of a skimmer basket having no handle.

A further object of the present invention is to provide a skimmer basket removal tool capable of removing the lid of the skimmer well where the skimmer basket is housed. This prevents the user from having the blindly use a finger or a secondary tool to remove the lid.

A still further object of the present invention is to provide a skimmer basket removal tool in accordance with the preceding objects which allows the user to grasp specific objects for removal from the pool or skimmer basket, an example of which is live animals.

In accordance with these and other objects, the present invention is directed to a tool used to remove a skimmer basket. The tool provides a mechanical means to remove the skimmer basket, remove objects from the skimmer basket and/or pool and facilitate the removal of the lid covering the skimmer basket well. This tool is designed to work with static skimmers and could be readily adapted to work with other water skimmers which rely on a removable skimmer basket.

The skimmer basket removal tool provided for herein takes the general shape and appearance of a pair of tongs and is generally referred to herein as “tongs” or “modified tongs”. The grasping portion of the tongs has been heavily modified and consists of two grasping elements. An exterior portion of both grasping elements located oppositely each other is serrated. These exterior portions are configured so that each grasping element rest against the other when the tongs are closed. This portion of the tool is configured to aid in the removal of specific debris from the skimmer basket or pool, but could be used to grasp a portion of the basket for handling purposed.

The forward most end of each grasping element has two hooks formed thereon, sometimes referred to herein as lid removal hooks. These hooks are configured to be received within the nearly ubiquitous circular opening found in the lid used with most skimmers. Once received within the lids top opening the tongs are opened allowing the hooks to catch on the underside surface of the lid, thereby facilitating its removal.

Located on the exterior of each of the tongs grasping elements is a hook, sometimes referred to herein as the basket removal hooks. These hooks are constructed so that either hook may be individually used to snag the handle of a skimmer basket, thereby facilitating is removal from the skimmer well.

Found near the distal end of each basket removal hook is a single spring pin which extends therefrom. The provided spring pin protrudes past the adjacent hook. Placing the tongs into the interior of a skimmer basket and opening it will result in the spring pins passing through openings in the skimmer basket. With the spring pins now in position, the skimmer basket may be removed by the user from the skimmer well.

These together with other improvements and advantages which will become subsequently apparent reside in the details of construction and operation as more fully hereinafter described and claimed, reference being made to the accompanying drawings forming a part hereof, wherein like numerals refer to like parts throughout.

### BRIEF DESCRIPTION OF THE DRAWINGS

The novel features believed to be characteristic of the invention, together with further advantages thereof, will be better understood from the following description considered in connection with the accompanying drawings in which a preferred embodiment of the present invention is illustrated by way of example. It is to be expressly understood, however, that the drawings are for the purpose of illustration and description only and are not intended as a definition of the limits of the invention.

FIG. 1 is an exploded perspective view of the tongs in accordance with the present invention.

FIG. 2 is a perspective side view of the tongs of FIG. 1 assembled and in the open position.

FIGS. 3 is another view of the tongs shown in FIG. 2 in the closed position.

FIG. 4A is a perspective side view of the tongs being inserted into the opening of a skimmer lid.

FIG. 4B is another perspective side view of the tongs and skimmer lid illustrated in FIG. 4A, in particular it is shown how the tongs engage with the opening of the skimmer lid during routine use.

FIG. 4C is an enlarged partial view of FIG. 4B showing how the tongs engage with the opening through the skimmer lid.

FIG. 5A is a perspective side view of the tongs and skimmer basket.

FIG. 5B is another perspective view of the tongs and skimmer basket shown in FIG. 5A, the skimmer basket has been cutaway to revel how the spring pin located near the distal end of each basket removal hook interacts with the skimmer basket.

FIG. 5C is an enlarged partial view of FIG. 5B showing how the spring pin located on the end of the basket removal hook interacts with the openings through the skimmer basket.

FIG. 6 is a perspective side view of the tongs being used to lift a skimmer basket by a handle provided thereon.

FIG. 7 shows a skimmer basket housed within a skimmer well.

### DETAILED DESCRIPTION OF THE PREFERRED EMBODIMENT

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

The present invention is directed towards a tool that may be used to remove a swimming pool skimmer basket from its housing. As used herein, the phrases tongs, pair of tongs and tool are used interchangeably.

It is to be understood that the term debris as used throughout this specification includes trash, pollen, insects, animals, leaves, grass, sticks and any particle, material or object that floats.

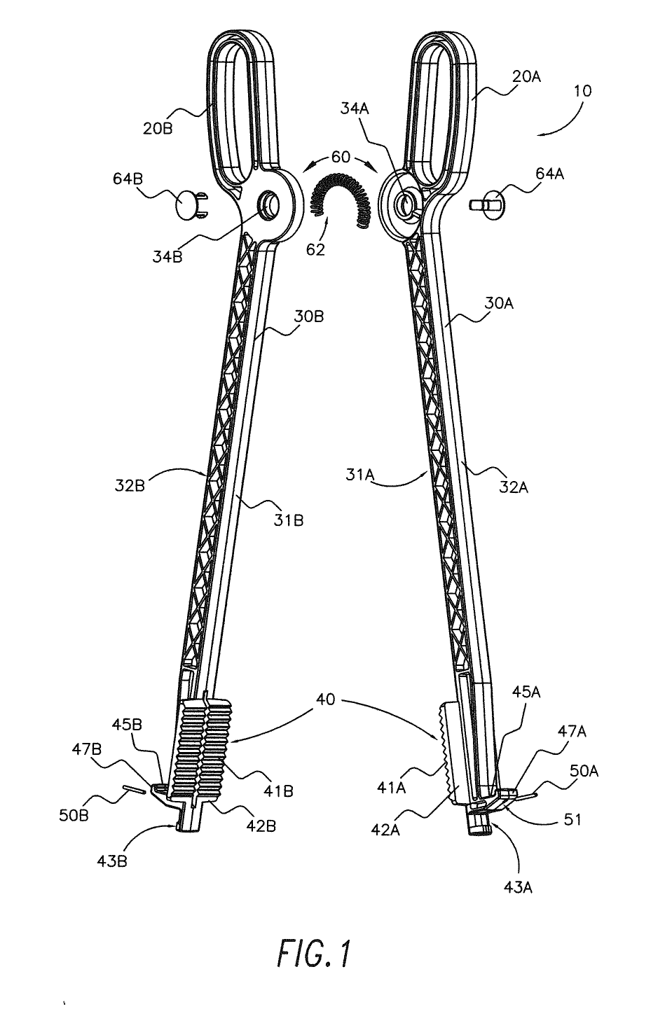

Turning now to the drawings in which like reference characters indicate corresponding elements throughout the several views, as used herein, the word “front” or “forward” corresponds to the end of the tongs where the grasping portion is located (i.e., at the bottom as shown in FIGS. 1-6); “rear” or “rearward” or “back” corresponds to the direction opposite the end of the tongs where the grasping portion is located (i.e., at the top as shown in FIGS. 1-6).

As shown in FIG. 1, the present invention is directed to a tong, generally designated by reference numeral 10, having two arms 30A and 30B. Each arm 30A and 30B has a handle 20A and 20B at its back end and a grasping element 42A and 42B at its forward end, respectively. It will be understood that the tongs 10 are intended to be employed in the removal of a swimming pool skimmer basket 91 and the removal of debris from the skimmer well 92 and skimmer basket 91; however with minor modification, some of its features could be used for other aspects of swimming pool maintenance.

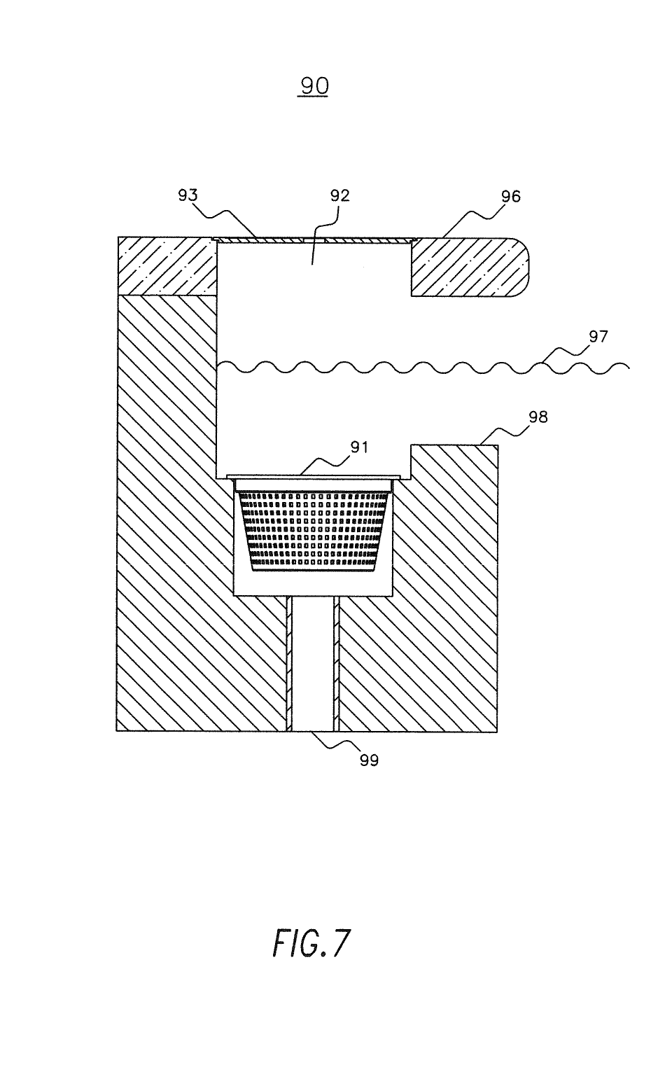

FIG. 7 shows a swimming pool skimmer 90 having a well 92 constructed to receive a removable skimmer basket 91. A lid 93 is used to cover the skimmer well 92. Static skimmers 90 are typically mounted near a swimming pools deck 96 with an opening 98 and a drain 99 that facilitates the circulation of water 97 therethrough.

In FIGS. 1-6, the preferred embodiment of the tongs 10 are shown. The tongs 10 have two arms 30A and 30B which together define an interior side wall 31A and 31B and an exterior side wall 32A and 32B, respectively. At the back end of each arm 30A and 30B is a handle 20A and 20B configured to be grasped by the user. At the front end of each arm 30A and 30B is a grasping element 42A and 42B, respectively. The grasping elements 42A and 42B are collectively referred to herein as the “grasping portion” 40.

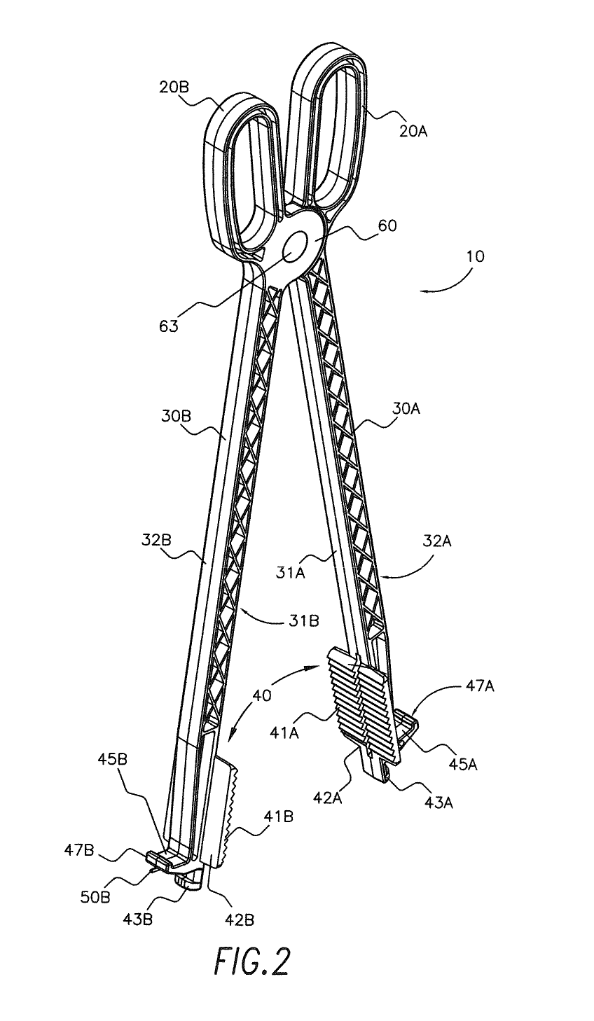

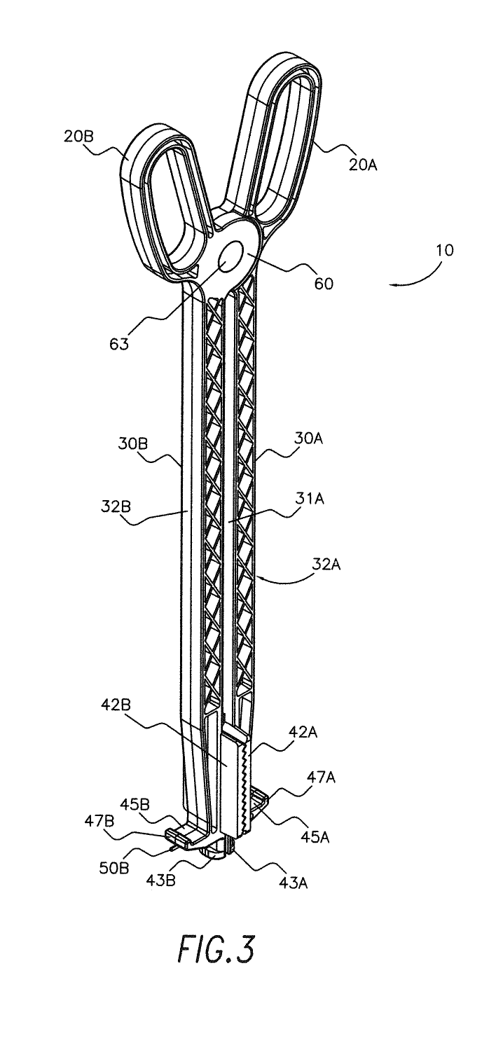

The two arms 30A and 30B are joined together at a joint 60 which allows the two arms to pivot about a fixed axis relative to each other. The joint 60 contains an internal compression spring 62 which biases the tongs into the closed position when not in use (see FIG. 3). The two arms 30A and 30B are secured together at the joint 60 through the use of a snap button 63. The snap button 63 has both a male portion 64A and a female portion 64B. The snap button 63 is received through an opening 34A and 34B found on each arm 30A and 30B, respectively (FIGS. 2-6).

The grasping portion 40 of the tongs 10 provides a series of structures which allow the user of the tool to perform a variety of task related to the maintenance of a swimming pool and more specifically a swimming pool skimmer.

Each of the grasping elements 42A and 42B each have an exterior portion 41A and 41B which defines thereon a series of serrated surfaces. When the tongs 10 are in the closed position, the serrations of each exterior portion 41A and 41B form a series of peaks and valleys which are complemented and received by those found on the opposing exterior portion (See FIG. 3, 4A & 6). The grasping elements 42A and 42B are ideal for grabbing an individual item of debris from the skimmer basket 91 or pool during maintenance. The number, shape and orientation of the serrations may be altered without departing from the scope of the invention disclosed herein.

Located on the exterior side wall 32A and 32B of each arm 30A and 30B is a hook 45A and 45B, respectively (FIGS. 1-3). These hooks 45A and 45B are sometimes referred to herein as “basket removal hooks”. The hooks 45A and 45B each define a ledge having a right angle bend at one end forming a lip. The lip also defines the distal end 47A and 47B of the hooks 45A and 45B. A lip formed from a non-right angle bend could perform equally as well and is not outside the scope of the present invention.

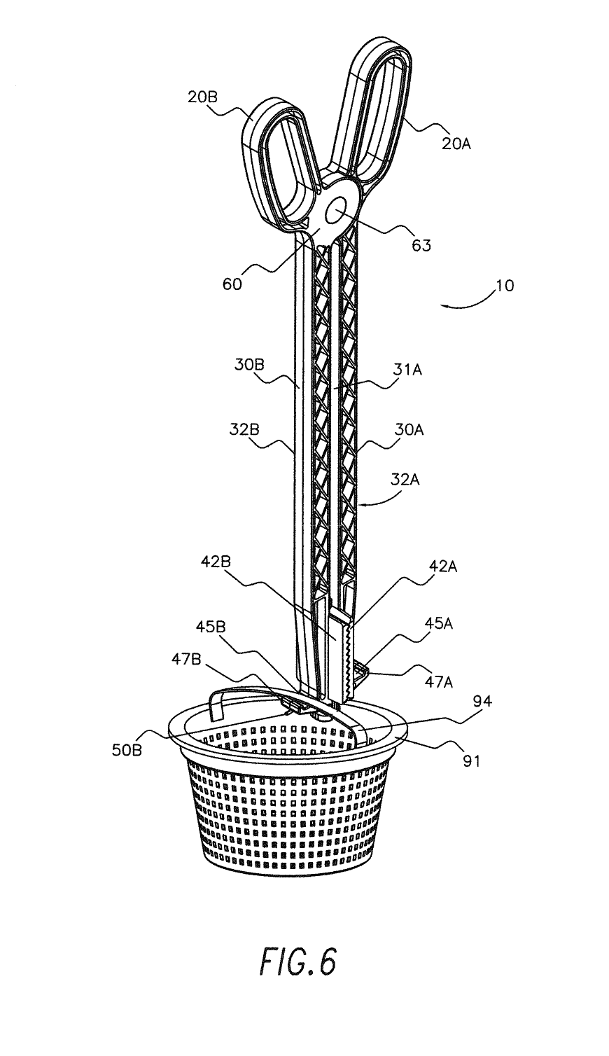

The ledge and lip portion of the basket removal hooks 45A and 45B are intended to facilitate “hooking” the handle 94 of a skimmer basket 91 so as to facilitate its removal from a skimmer (see FIGS. 6-7). By placing either hook 45A or 45B under a skimmer basket 91 handle 94 the user need only pull up to remove the basket from the skimmer well 92.

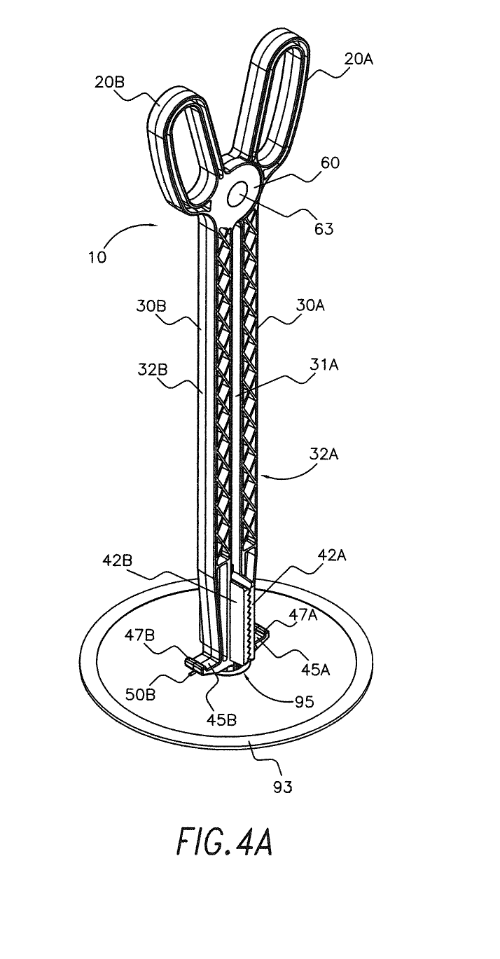

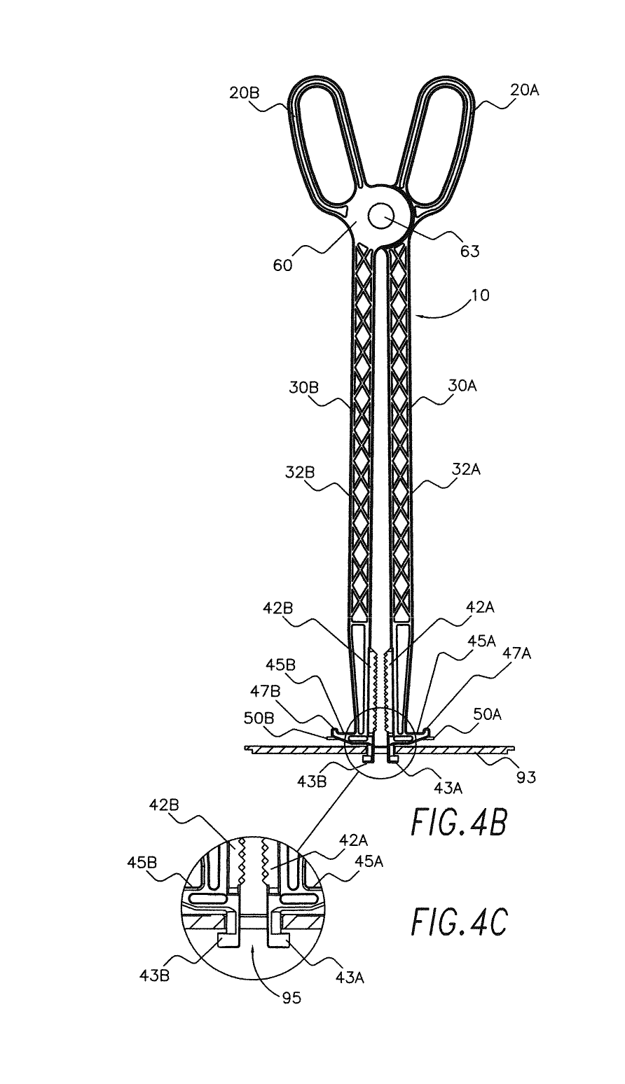

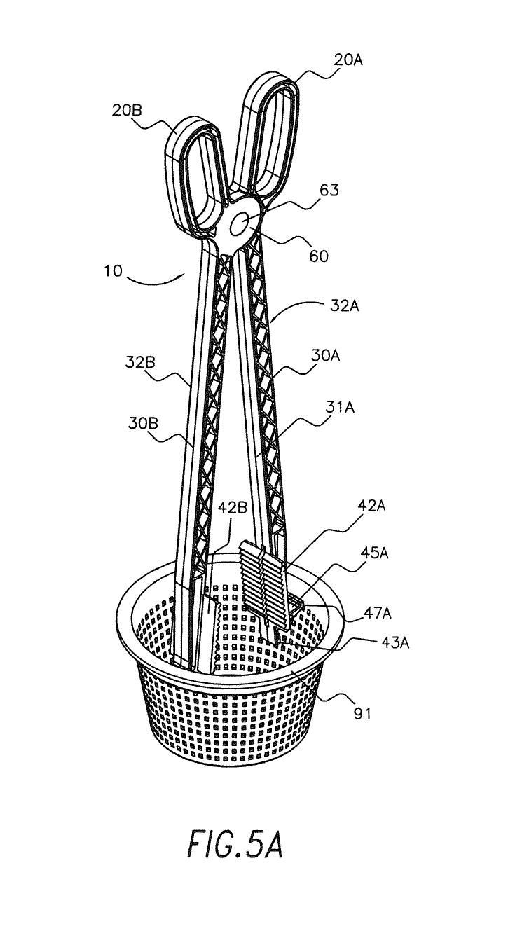

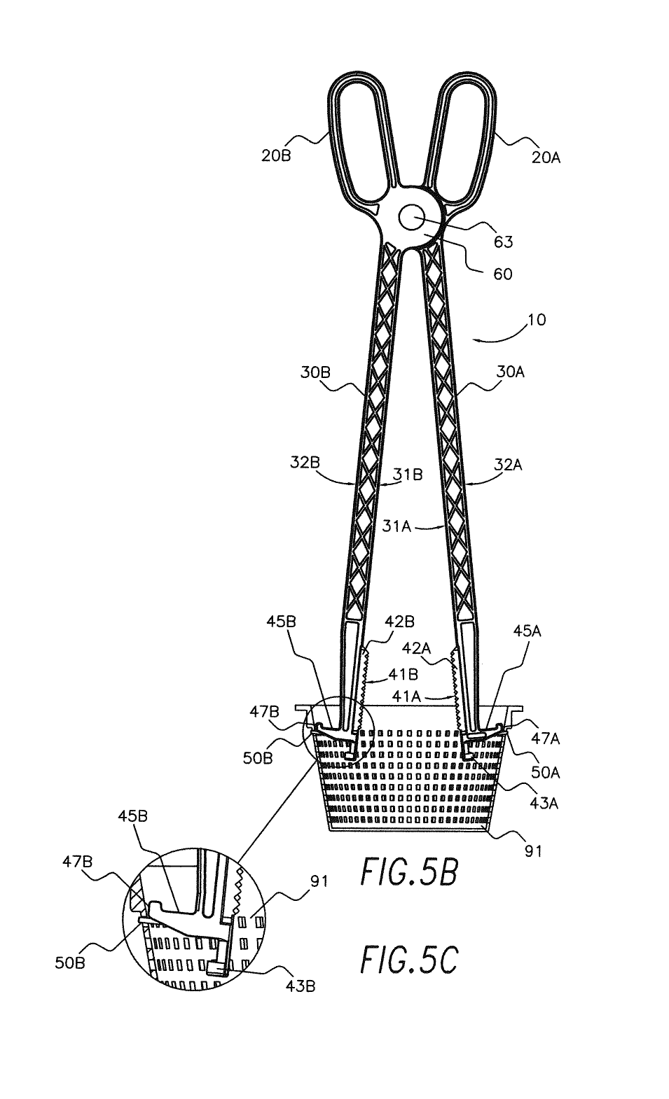

Located below and adjacent to the distal end 47A and 47B of each basket removal hook 45A and 45B is an opening which receives a spring pin 50A and 50B, respectively. An opening 51 on hook 45A for spring pin 50A is shown in FIG. 1. Not shown but also present is an identical opening on hook 45B for spring pin 50B. When secured within there respective openings, each of the spring pins 50A and 50B protrudes past the distal ends 47A and 47B of each hook 45A and 45B, respectively (FIGS. 4B, 5B & 5C). The spring pins 50A and 50B may be substituted with dowels or other objects of appropriate shape and strength without departing from the scope of the invention described herein.

In use, the tongs 10 are initially inserted into the dirty skimmer basket. The user then grasps the handles 20A and 20B, squeezing them together in order to cause the arms 30A and 30B to spread apart (FIG. 2). Eventually the distal end 47A and 47B of each hook 45A and 45B will come into contact with the interior of the skimmer basket 91. Occurring as a result of the arms 30A and 30B opening, the spring pins 50A and 50B are received through two separate openings of the skimmer basket 91. At this time the skimmer basket 91 may be removed from the swimming pool skimmer in which it is housed (FIGS. 5A, 5B, 5C & 7).

The length of the spring pins 50A and 50B is selected so that they may be received within the myriad of openings in the skimmer basket 91 (FIGS. 5A, 5B and 5C). The spring pins 50A and 50B, or there substitute, may not be of such a size (length or diameter) as to be impossible to insert into the openings of the skimmer basket 91.

Two hooks 43A and 43B extend from the front of the tongs 10 arms 30A and 30B, respectively (FIGS. 1-3, 4B & 4C). Hooks 43A and 43B are also referred herein as “lid removal hooks”. In the tongs 10 closed position the two hooks 43A and 43B come to rest against each other. Each hook 43A and 43B defines a lip at it's distil end having a right angle bend or an approximate right angle bend. A lip formed from a non-right angle bend may perform equally as well and is not outside the scope of the present invention. The hooks 43A and 43B in combination have an exterior diameter which does not prevent them from being inserted into the opening 95 through the skimmer lid 93 (FIGS. 4A, 4B & 4C).

To use the hooks 43A and 43B present on the front end of the tongs 10 to remove the skimmer lid 93, the tongs 10 must be in the closed position. The two hooks 43A and 43B are then inserted into the opening 95 of the skimmer lid 93 as shown in FIGS. 4A, 4B and 4C. The user will then grasp the handles 20A and 20B of the tongs 10 and squeeze them together. This results in the arms 30A and 30B and the hooks 43A and 43B spreading apart. As the hooks 43A and 43B spread apart the lip portion of each “hooks” under the lid 93 allowing the user to simply pull the lid 93 off of a swimming pool skimmer 90 well 92 (see FIGS. 4A, 4B, 4C & 7).

The tongs 10 are manufactured entirely from an injection molded polymer, except for the spring pins 50A and 50B and the compression spring 62. The advantage of this material selection is that the tong will float if dropped into water during use. Other suitable materials may be substituted without departing from the entire scope of the present invention.

The tongs 10 is assembled as follows. The compression spring 62 is inserted into one half of the joint 60 while the two halves of the joint 60 are placed against one another. The female portion of the snap button 64B is inserted through the openings 34A and 34B of each arm 30A and 30B. Next, the male portion 64A of the snap button 63 is inserted into the female portion 64B. By assembling the snap button 63, the compression spring 62 is secured within the joint 60 and the two arms 30A and 30B of the tongs 10 are secured together.

To disassemble the tongs 10, simple reverse the steps outline above.

The shape and texture of the handles 20A and 20B may be varied without departing from the scope of the invention disclosed herein.

In an alternate embodiment, the tongs could omit the serrations present on the exterior portion 41A and 41B of the grasping elements 42A and 42B. Instead the grasping elements 42A and 42B could be shaped and contoured to facilitate grasping foreign objects.

The foregoing descriptions and drawings should be considered as illustrative only of the general principles of the invention. This invention is not limited for use with static skimmers affixed to the side of a swimming pool; rather it may be used with any water skimmer which relies on a removable skimmer basket to collect debris from the water. The invention may be constructed with a variety of dimensional variation and is not limited by the dimensions of the preferred embodiment unless otherwise specified. Numerous applications of the present invention will readily occur to those skilled in the art.

Therefore, it is not desired to limit the invention to the specific examples disclosed or the exact construction and operation shown and described. Rather, all suitable modifications and equivalents may be resorted to, falling within the scope of the invention.

What is claimed is:

1. A pair of tongs for use with a swimming pool skimmer, comprising:
a first arm connected to a handle at one end and a work piece engaging end at the other, said first arm defining at least an interior side wall and exterior side wall;
a second arm connected to a handle at one end and a work piece engaging end at the other, said second arm defining at least an interior side wall and an exterior side wall;
said second arm is pivotally connect to said first arm;
defined on said work piece engaging end of said first arm and said second arm is a structure on each of said exterior side walls from which a longitudinally extending shaft protrudes.

2. The pair of tongs as set forth in claim 1, further comprising a spring which biases said first arm and said second arm into a closed position.

3. The pair of tongs as set forth in claim 1, wherein each of said structures of said first arm and said second arm consists of a ledge which occupies a plane running approximately perpendicular to the longitudinal axis of the arm from which it extends, said ledge defining a lip at its distal end.

4. The pair of tongs as set forth in claim 3, wherein said longitudinally extending shaft protrudes past said lip.

5. The pair of tongs as set forth in claim 4, wherein said first arm and said second arm each define a hook on the forward most portion of said work piece engaging end.

6. The pair of tongs as set forth in claim 5, wherein said work piece engaging end of said first arm and said second arm also includes a grasping portion, said grasping portion is located below said interior side wall.

7. The pair of tongs as set forth in claim 6, wherein said grasping portion of said first arm and said second arm is serrated.

8. Tool for removing a swimming pool skimmer basket, comprising:
a handle portion including a pair of handle elements
a grasping portion including a pair of grasping elements,
a pair of longitudinally extending arms connected to a handle element at one end and defining a grasping element at the other end thereof;
said pair of longitudinally extending arms being pivotally connected together to provide a scissor type connection therebetween;
said pair of grasping elements individually defining an inwardly facing contact surface that is complementary to the other inwardly facing contact surface of the oppositely located grasping element;
each of said pair of longitudinally extending arms provides a protruding support structure having a lip on its distal end, a longitudinally extending member protruding from said support structure, and a hook located on its forward most end that is offset from said support structure;
said support structure being located adjacent to said grasping elements.

9. The tool as set forth in claim 8, said tool is further comprised of a spring which biases said longitudinally extending arms together such that said pair of grasping elements contact each other.

10. The tool as set forth in claim 9, wherein said inwardly facing contact surfaces of said pair of grasping elements are serrated.

11. The tool as set forth in claim 9, wherein said support structure has the general shape of a hook.

12. The tool as set forth in claim 9, wherein said longitudinally extending member is located below said lip of said support structure.

13. The tool as set forth in claim 12, wherein said longitudinally extending member protrudes past said lip of said support structure.

14. The tool as set forth in claim 13, wherein said longitudinally extending member is a spring pin or a roll pin.
